(19) United States
(12) Patent Application Publication
(10) Pub. No.: US 2024/0331588 A1
(43) Pub. Date: Oct. 3, 2024

(54) Decorative Blind Device

(71) Applicant: Anne Tonaszuck, Duxbury, MA (US)

(72) Inventor: Anne Tonaszuck, Duxbury, MA (US)

(21) Appl. No.: 18/623,562

(22) Filed: Apr. 1, 2024

Related U.S. Application Data
(60) Provisional application No. 63/493,083, filed on Mar. 30, 2023.

(51) Int. Cl. G09F 23/00; E06B 9/32; E06B 9/386

(52) U.S. Cl. CPC G09F 23/00; E06B 9/32; E06B 9/386

(57) ABSTRACT

A decorative blind device is provided. The device is comprised of a decorative blind device comprised of a window or door blind assembly. Each blind of the blind assembly is comprised of a partial indicia that is positioned on a surface of the blind. When all blinds are closed, each partial indicia forms a complete indicia.

### CROSS-REFERENCE TO RELATED APPLICATION

The present application claims priority to, and the benefit of, U.S. Provisional Application No. 63/493,083, which was filed on Mar. 30, 2023, and is incorporated herein by reference in its entirety.

### FIELD OF THE INVENTION

The present invention relates generally to the field of window blinds. More specifically, the present invention relates to a decorative blind device that provides a window blind assembly with indicia positioned on each blind such that the blinds form a complete indicia when the blinds are closed. Accordingly, the present disclosure makes specific reference thereto. Nonetheless, it is to be appreciated that aspects of the present invention are also equally applicable to other like applications, devices, and methods of manufacture.

### BACKGROUND

In many homes, windows without coverings can leave inhabitants feeling exposed, especially in urban settings or areas with close neighbors. As a result, many individuals choose to install window blinds to enhance their privacy. Blinds offer the dual benefit of shielding interiors from prying eyes while still allowing the flexibility to let in varying amounts of natural sunlight. This balance between privacy and illumination is essential for creating a comfortable living environment.

However, standard blinds, with their often plain and generic designs, can sometimes feel monotonous and lackluster. For homeowners with a keen eye for design, this poses a challenge. They might find it difficult to find blinds that not only serve the functional purpose but also complement and elevate their home décor. The aesthetics of a room can be significantly influenced by the choice of window treatments, and settling for something that doesn't align with the room's theme or the homeowner's personal style can disrupt the harmony of the space. In summary, while blinds are undeniably practical, there's a growing demand for options that are both functional and stylish, allowing homeowners to seamlessly integrate them into their interior design visions.

Therefore, there exists a long-felt need in the art for an improved window blind. There also exists a long-felt need in the art for a decorative blind device. More specifically, there exists a long-felt need in the art for a decorative blind device that provides decorative window blinds. In addition, there exists a long-felt need in the art for a decorative blind device that provides decorative window blinds with indicia positioned on the blinds of the device itself.

The subject matter disclosed and claimed herein, in one embodiment thereof, comprises a decorative blind device. The device is comprised of a decorative blind device comprised of a window or door blind assembly. Each blind of the blind assembly is comprised of a partial indicia that is positioned on a surface of the blind. When all blinds are closed, each partial indicia forms a complete indicia.

In this manner, the decorative blind device of the present invention accomplishes all the forgoing objectives and provides an improved window blind. More specifically, the device provides decorative window blinds. To do so, the device provides decorative window blinds with indicia positioned on the blinds of the device itself that can be viewed when the blinds are closed but cannot be viewed when the blinds are open.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a decorative blind device comprised of at least one window blind with at least one indicia on the surface of the blind. In this manner, multiple blinds of the device may each be comprised of indicia such that the indicia of each blind forms a complete indicia when the blinds are closed.

The device is also comprised of at least one frame that attaches to a wall surface via at least one wall attachment fastener. At least one horizontal or vertical blind attaches to the frame. The blind attaches to the frame via at least one ladder string.

The device is comprised of at least one lift control that allows the blinds to be raised/lowered. Furthermore, the device is comprised of at least one tilt control that allows a user to rotate the blinds to open/close.

The front surface and/or rear surface of each blind is comprised of at least one partial indicia. The partial indicia may be printed, painted, embossed, etc. on the blind. When all blinds are closed (i.e., not allowing light through a window or door), the indicia forms a complete indicia picture across all blinds which provides a decorative image that is displayed on the blinds.

The present invention is also comprised of a method of using the device. First, a device is provided comprised of a frame comprised of at least one blind with at least one indicia printed on a surface of the blind. Then, a user can raise the blind via at least one lift control. Then, a user can tilt the blind via at least one tilt control. Next, a user can lower the blind via the lift control. Finally, a user can use the tilt control to close the blind such that the indicia on the blind forms a complete indicia across all blinds of the device.

Accordingly, the decorative blind device of the present invention is particularly advantageous as it provides an improved window blind. More specifically, the device provides decorative window blinds. To do so, the device provides decorative window blinds with indicia positioned on the blinds of the device itself that can be viewed when the blinds are closed but cannot be viewed when the blinds are open. In this manner, the decorative blind device overcomes the limitations of existing window blinds known in the art which may be boring or uninspiring.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a decorative blind device of the present invention while the blinds of the device are closed in accordance with the disclosed architecture; and

FIG. 2 illustrates a flowchart of a method of using one potential embodiment of a decorative blind device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved window blind. There also exists a long-felt need in the art for a decorative blind device. More specifically, there exists a long-felt need in the art for a decorative blind device that provides decorative window blinds. In addition, there exists a long-felt need in the art for a decorative blind device that provides decorative window blinds with indicia positioned on the blinds of the device itself.

The present invention, in one exemplary embodiment, is comprised of a decorative blind device. The device is comprised of at least one window blind with at least one indicia on the surface of the blind. Multiple blinds of the device may each be comprised of indicia such that the indicia of each blind forms a complete indicia when the blinds are closed.

The device is also comprised of at least one frame that attaches to a wall surface via at least one wall attachment fastener. At least one horizontal or vertical blind attaches to the frame via at least one ladder string. The device is also comprised of at least one lift control that allows the blinds to be raised/lowered. Furthermore, the device is comprised of at least one tilt control that allows a user to rotate the blinds to open/close.

The front surface and/or rear surface of each blind is comprised of at least one partial indicia. The partial indicia may be printed, painted, embossed, etc. on the blind. When all blinds are closed (i.e., not allowing light through a window or door), the indicia forms a complete indicia picture across all blinds which provides a decorative image that is displayed on the blinds.

The present invention is also comprised of a method of using the device. First, a device is provided comprised of a frame comprised of at least one blind with at least one indicia printed on a surface of the blind. Then, a user can raise the blind via at least one lift control. Then, a user can tilt the blind via at least one tilt control. Next, a user can lower the blind via the lift control. Finally, a user can use the tilt control to close the blind such that the indicia on the blind forms a complete indicia across all blinds of the device.

Accordingly, the decorative blind device of the present invention is particularly advantageous as it provides an improved window blind. More specifically, the device provides decorative window blinds. To do so, the device provides decorative window blinds with indicia positioned on the blinds of the device itself that can be viewed when the blinds are closed but cannot be viewed when the blinds are open. In this manner, the decorative blind device overcomes the limitations of existing window blinds known in the art which may be boring or uninspiring.

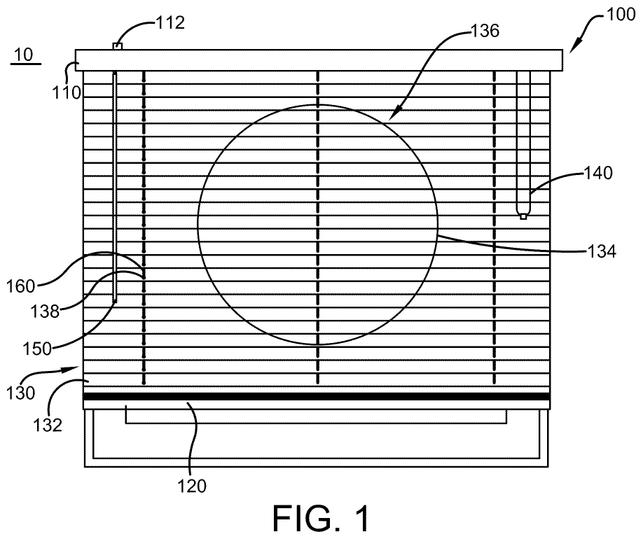

Referring initially to the drawings, FIG. 1 illustrates a perspective view of one potential embodiment of a decorative blind device 100 of the present invention while the blinds 130 of the device 100 are closed in accordance with the disclosed architecture. The device 100 is comprised of at least one window blind 130 with at least one indicia 134 on the surface 132 of the blind 130. In this manner, multiple blinds 130 of the device 100 may each be comprised of indicia 134 such that the indicia 134 of each blind 130 forms a complete indicia 136 when the blinds 130 are closed.

The device 100 is comprised of at least one frame 110. The frame 110 attaches to a wall surface 10 via at least one wall attachment fastener 112. The fastener 112 may include but is not limited to a bolt, a screw, a magnet, a mounting bracket, etc.

At least one horizontal or vertical blind 130 attaches to the frame 110. The blinds 130 may be any style of window blinds known in the art. This includes but is not limited to a vertical blind, a standard vertical blind, a panel track blind, a horizontal blind, a Venetian blind, a mini blind, a micro blind, a roller blind, a standard roller blind, a dual roller blind, a roman blind, a flat roman blind, a hobbled or looped roman blind, a pleated blind, a honeycomb or cellular blind, a bamboo and woven wood blind, a standard bamboo blind, a woven wood blind, a sheer blind, a sheer vertical blind, a sheer horizontal blind, a smart blind, a motorized blind, a solar-powered blind, a blackout blind, a standard blackout blind, a thermal blackout blind, a shutter blind, a plantation shutter, a traditional shutter, a day and night blind, a vision blind, or a skylight blind.

More specifically, the blind 130 attaches to the frame 110 via at least one ladder string 160. The string 160 is fed vertically through at least one opening 138 in each blind 130 in order to secure the blinds 130 in position.

The device 100 is comprised of at least one lift control 140. The lift control 140 allows the blinds 130 to be raised/lowered. The lift control 140 is preferably a cord loop, a cord, a wand, a push button, a motorized control, or other similar structure of the like that can be grabbed by a user.

The device 100 is also comprised of at least one tilt control 150. The tilt control 150 allows a user to rotate the blinds 130. The blinds 130 may rotate 180 degrees relative to the ladder string 160 to allow the blinds 130 to open/close. The control 150 is preferably a cord loop, a cord, a wand, a push button, a motorized control, or other similar structure of the like that can be grabbed by a user.

The front surface and/or rear surface 132 of each blind 130 is comprised of at least one partial indicia 134. The partial indicia 134 may be printed, painted, embossed, etc. on the blind 130. When all blinds 130 are closed (i.e., not allowing light through a window or door), the indicia 134 forms a complete indicia picture 136 across all blinds 130. This provides a decorative image that is displayed on the blinds 130. The indicia picture 136 may be any indicia such as but not limited to a logo, an image, a symbol, a picture, a character, a person, a scene, a pattern, a number, a letter, etc.

The device 100 is also comprised of at least one bottom rail 120. The bottom rail 120 is positioned underneath the last blind 130 and is weighted. In this manner, the rail 120 ensures the blinds 130 hang straight.

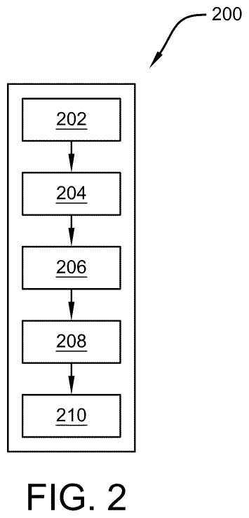

The present invention is also comprised of a method of using 200 the device 100, as seen in FIG. 2. First, a device 100 is provided comprised of a frame 110 comprised of at least one blind 130 with at least one indicia 134 printed on a surface 132 of the blind 130 [Step 202]. Then, a user can raise the blind 130 via at least one lift control 140 [Step 204]. Then, a user can tilt the blind 130 via at least one tilt control 150 [Step 206]. Next, a user can lower the blind 130 via the lift control 140 [Step 208]. Finally, a user can use the tilt control 150 to close the blind 130 such that the indicia 134 on the blind 130 forms a complete indicia 136 across all blinds 130 of the device 100 [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “decorative blind device” and “device” are interchangeable and refer to the decorative blind device 100 of the present invention.

Notwithstanding the forgoing, the decorative blind device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the decorative blind device 100 as shown in the FIGS. are for illustrative purposes only, and that many other sizes and shapes of the decorative blind device 100 are well within the scope of the present disclosure. Although the dimensions of the decorative blind device 100 are important design parameters for user convenience, the decorative blind device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A decorative blind device comprising:
a frame;
a blind attached to the frame via a ladder string, a surface of the blind comprised of an indicia;
a bottom rail;
a tilt control; and
a lift control.

2. The decorative blind device of claim 1, wherein the blind is comprised of a vertical blind, a standard vertical blind, a panel track blind, a horizontal blind, a Venetian blind, a mini blind, a micro blind, a roller blind, a standard roller blind, a dual roller blind, a roman blind, a flat roman blind, a hobbled or looped roman blind, a pleated blind, a honeycomb or cellular blind, a bamboo and woven wood blind, a standard bamboo blind, a woven wood blind, a sheer blind, a sheer vertical blind, a sheer horizontal blind, a smart blind, a motorized blind, a solar-powered blind, a blackout blind, a standard blackout blind, a thermal blackout blind, a shutter blind, a plantation shutter, a traditional shutter, a day and night blind, a vision blind, or a skylight blind.

3. The decorative blind device of claim 1, wherein the frame is comprised of a fastener.

4. The decorative blind device of claim 1, wherein the blind is comprised of an opening.

5. The decorative blind device of claim 4, wherein the ladder string is positioned through the opening.

6. The decorative blind device of claim 1, wherein the tilt control is comprised of a cord loop, a cord, a wand, a push button, or a motorized control.

7. The decorative blind device of claim 1, wherein the lift control is comprised of a cord loop, a cord, a wand, a push button, or a motorized control.

8. The decorative blind device of claim 1, wherein the bottom rail is comprised of a weighted bottom rail.

9. A decorative blind device comprising:
a frame;
a first horizontal blind attached to the frame via a ladder string, a first surface of the first horizontal blind comprised of a first indicia;
a second horizontal blind attached to the frame via the ladder string, a first surface of the second horizontal blind comprised of a second indicia;
a bottom rail;
a tilt control; and
a lift control.

10. The decorative blind device of claim 9, wherein the frame is comprised of a fastener.

11. The decorative blind device of claim 9, wherein the blind is comprised of an opening.

12. The decorative blind device of claim 11, wherein the ladder string is positioned through the opening.

13. The decorative blind device of claim 9, wherein the tilt control is comprised of a cord loop, a cord, a wand, a push button, or a motorized control.

14. The decorative blind device of claim 9, wherein the lift control is comprised of a cord loop, a cord, a wand, a push button, or a motorized control.

15. The decorative blind device of claim 9, wherein the first indicia and the second indicia form a complete indicia when the first horizontal blind and the second horizontal blind are closed.

16. The decorative blind device of claim 15, wherein the complete indicia is comprised of a logo, an image, a symbol, a picture, a character, a person, a scene, a pattern, a number, or a letter.

17. The decorative blind device of claim 9, wherein the bottom rail is comprised of a weighted bottom rail.

18. A method of using a decorative blind device, the method comprising the following steps:
providing a decorative blind device comprised of a frame comprised of a blind with an indicia on a surface of the blind;
raising the blind via a lift control;
tilting the blind via a tilt control;
lower the blind via the lift control;
close the blind via the tilt control.

19. The method of using a decorative blind device of claim 18, wherein the indicia is comprised of a logo, an image, a symbol, a picture, a character, a person, a scene, a pattern, a number, or a letter.

20. The method of using a decorative blind device of claim 19, wherein the indicia is comprised of a portion of the logo, the image, the symbol, the picture, the character, the person, the scene, the pattern, the number, or the letter.
